(19) United States
(12) Patent Application Publication
(10) Pub. No.: US 2004/0207703 A1
(43) Pub. Date: Oct. 21, 2004

(54) Ink jet recording method and ink jet recording device

(75) Inventor: Takatsugu Doi, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/826,410

(22) Filed: Apr. 19, 2004

(30) Foreign Application Priority Data
Apr. 21, 2003 (JP) 2003-115267

(51) Int. Cl. B41J 2/135

(52) U.S. Cl. 347/100

(57) ABSTRACT

The present invention provides an ink jet recording method using a first liquid and a second liquid wherein at least one of these liquids contains a colorant. The method includes providing the first liquid on a recording medium and providing the second liquid so as to be in contact with a region where the first liquid has been provided on the recording medium, to thereby form an image. The contact angle of the second liquid with respect to plain paper is less than 85° and the contact angle of the second liquid with respect to the region where the first liquid is provided on the plain paper is 60° or more.

### BACKGROUND OF THE INVENTION

1. Field of the Invention

The present invention relates to an ink jet recording method and to an ink jet recording device.

2. Description of the Related Art

A so-called ink jet system, in which liquid or molten solid ink is jetted from an ink jetting port such as a nozzle, slit or porous film has the characteristics that it is small-sized and inexpensive and is therefore used in many printers. Among these ink jet systems, for example, a piezo ink jet system which jets ink by making use of the deformation of a piezoelectric element and a thermal ink jet system which utilizes an ink boiling phenomenon due to thermal energy are frequently used in view of high resolution and high-speed printing ability. Also, an ink jet printer can print not only on paper such as plain paper and paper dedicated for ink jet printing but also on films such as OHP sheets and clothes.

Currently, higher-speed and higher quality are among important objects of ink jet printers. A method has been proposed for the purpose of attaining both higher-speed and higher quality, in which a liquid containing a compound having a cationic group is adhered to a recording medium, ink containing an anionic dye is then adhered to the recording medium just after the liquid has penetrated through the recording medium, and the region to which the liquid is adhered on the recording medium is dried, to form an image (see Japanese Patent No. 2667401). However, in this method, there are cases where only insufficient image density is obtained when the time for drying ink is shortened. Also, there are cases where only insufficient long term reliability is obtained when printing is carried out using smaller dropping amounts.

An ink jet method has also been proposed for the purpose of promoting the micronization and sphericity of an ink dot and for the purpose of improving penetration into a recording medium, wherein an image receiving member having water repellency has a static contact angle of 10 to 30 degrees with recording ink (see Japanese Patent Application Laid-Open (JP-A) No. 9-142008). In this method, however, the image receiving member is limited to those having the characteristics as mentioned above. Therefore, the above effect cannot be obtained in the case of using plain paper as the image recording member.

Further, an ink for ink jet printing has been proposed with the intention of improving color forming ability and continuous printing ability, which ink includes a silicone type surfactant, and water or water and a water-soluble organic solvent wherein the water has a specific resistance of 3 kΩ·cm or more (see JP-A No. 2002-138227). However, in this method, there are cases where a loss of color-edge definition between colors, so called ICB(Intercolor Bleeding), is caused when different colors are printed at neighboring positions.

As explained above, these conventional technologies cannot simultaneously satisfy the requirements with respect to optical density, feathering, ICB, drying time and long-term reliability.

The inventors of the invention have made further studies, as will be explained below, to solve the above problems, and particularly, the ICB.

In a case of forming images with different colors at neighboring positions in a recording method utilizing an ink jet system, it is known that there is a phenomenon (so-called ICB)) which occurs such that inks having different colors and arranged adjacent to each other on a recording medium undergo color mixing between the colors during printing. Although the mechanism by which the ICB occurs has not been clarified, it is inferred to be as follows.

First, the behavior of ink when only one color ink is provided on a recording medium will be explained. When ink is provided on the recording medium, the ink is considered to be diffused in two directions, namely, the direction of the depth of the recording medium and the direction of the horizontal plane of the recording medium (the direction of the paper plane).

The diffusion of a liquid such as ink in the direction of the depth of paper is said to be given by the Lucas-Washburn equation represented by the following formula (1).

$$h = \sqrt{\frac{γ \times r \times t \times cos θ}{2 \times η}} \qquad Equation ( 1 )$$

In the equation (1), h is a depth to which the liquid penetrates in the paper, γ is a surface tension of the liquid, r is an average diameter of capillary tubes of the paper, t is a penetration time, θ is a contact angle of the paper fiber with the liquid and η is a viscosity of the liquid.

According to this Lucas-Washburn equation, the depth h to which ink penetrates after a fixed time has passed may be expressed by γrcosθ/η.

Here, γ and η are values determined by the properties of the ink, that is, primarily by the composition of the ink, and r is a characteristic value of the recording medium. θ is a contact angle formed between the ink and the recording medium and is determined by a combination of the structural materials of the recording medium, such as cellulose fibers and sizing agents, and the ink. Therefore, in the case of ink having large values for γ and cos θ and a small value for η, the penetrability of this ink in the direction of the depth of the recording medium is expected to be large.

On the other hand, the spread of the ink in the direction of the surface of the recording medium is considered to be determined by the balance between the penetrability of the ink in the direction of the depth of the recording medium and the contact angle (θ) of the paper with the ink. Namely, the spread of the ink is expected to be increased in the direction of the surface of the paper when the penetrability of the ink in the direction of the depth of the recording medium is small and the contact angle of the recording medium with the ink is small. Because the surface of plain paper is generally made hydrophobic, an action is exerted on the ink in the direction in which the spread of the ink in the direction of the surface of the paper is suppressed is exerted on the ink.

As mentioned above, the behavior of only one ink penetrated into a recording medium is determined not only by the characteristics of the ink but also by a combination of the characteristics of the recording medium and the interaction between the recording medium and the ink.

Next, the behavior of ink penetrated into a recording medium when inks having two or more colors are provided on the recording medium will be explained. When an ink is provided to a part where ink which is different from the ink to be provided already exists, the interaction between the ink provided afterward and the recording medium becomes small, and a control factor of the result is the diffusion into one liquid (ink) of another liquid (other ink).

This inhibits the aforementioned action that suppresses the spread of ink in the direction of the surface of the paper due to the interaction between the plain paper and the ink.

Therefore, when another ink is provided to a part where ink already exists on a recording medium, depending on the presence of the interaction between the two inks or the extent of the interaction, a region where the diffusion of another ink into the existing ink is more dominant than the interaction between the plain paper and the ink and a region contrary to this are produced irregularly on the recording medium. This means that places where color mixing arises and places where less color mixing arises are intermingled. As a consequence, it is considered that when an image provided with different colors arranged adjacent to each other is formed on the recording medium, a ICB is caused.

Among conventional ink jet inks, few have undergone design related to the diffusion between inks having different colors. Several methods has been proposed for the purpose of improving this ICB. These methods however have insufficient effects.

For example, a method of printing so as to prevent inks having different colors from not being in contact with each other by making the printing time of one ink having one color different from the printing time of another ink having a different color has been proposed (for example, JP-A No. 9-193529). However, in this method, the effect of improving the ICB cannot be obtained in the case of printing at a high speed.

As another method, a method has been proposed in which colorants in inks are designed so that coagulation occurs among them when the different inks are brought into contact with each other, to prevent color mixing between inks (for example, U.S. Pat. No. 518,105 and JP-A Nos. 6-106735 and 7-145336). However, in this method, it is necessary to add a coagulant to ink, and there are therefore cases where long-term reliability is not obtained depending on the combination with a head.

Based on the above circumstances, the inventors have made earnest studies and as a result found that it is important to control the contact angle of a recording medium with a liquid such as ink when other liquids such as inks are added to a region where the former liquid is supplied. This finding has lead to the achievement of the invention.

### SUMMARY OF THE INVENTION

The present invention has been made in view of the above circumstances and provides an ink jet recording method, which can prevent a ICB, and also provides an ink jet recording device.

A first aspect of the invention is to provide an ink jet recording method using a first liquid and a second liquid wherein at least one of the liquids contains a colorant, the method comprising: Providing the first liquid on a recording medium and providing the second liquid so as to be in contact with a region where the first liquid has been provided on the recording medium, to thereby form an image, wherein; a contact angle of the second liquid with respect to plain paper is less than 85° and a contact angle of the second liquid with respect to the region where the first liquid is provided on plain paper is 60° or more.

A second aspect of the invention is to provide an ink jet recording device comprising: a recording head provided with two or more nozzles respectively jetting two or more liquids respectively onto a surface of a recording medium, the device using a first liquid and a second liquid as the two or more liquids, wherein: at least one of the first and second liquids contains a colorant; an image is formed at least by jetting the first liquid from the recording head onto the recording medium and jetting the second liquid from the recording head so as to be in contact with a region where the first liquid has been provided on the recording medium; a contact angle of the second liquid with respect to plain paper is less than 85°; and a contact angle of the second liquid with respect to the region where the first liquid is provided on the plain paper is 60° or more.

### BRIEF DESCRIPTION OF THE DRAWINGS

FIG. 1 is a schematic view showing a print pattern A printed on paper.

FIG. 2 is a schematic view showing a print pattern B printed on paper.

FIG. 3 is a schematic view showing a print pattern C printed on paper.

### DETAILED DESCRIPTION OF THE INVENTION

An ink jet recording method and an ink jet recording device of the present invention will be described separately below.

<Ink Jet Recording Method>

The ink jet recording method of the invention is characterized in that the method uses a first liquid and a second liquid wherein at least one of these liquids contains a colorant, the method including providing the first liquid on a recording medium and providing a second liquid so as to be in contact with the region where the first liquid has been provided on the recording medium, to thereby form an image, wherein (1) the contact angle of the second liquid with respect to plain paper is less than 85° and (2) the contact angle of the second liquid with respect to the region where the first liquid is provided on the plain paper is 60° or more.

Therefore, a ICB can be prevented when printing an image by using the ink jet recording method of the invention.

Also, no particular limitation is imposed on the properties and compositions of the first and second liquids in the ink jet recording method of the invention insofar as the first and second liquids satisfy the above (1) and (2) and at least one of them contains a colorant. As a result, the degree of freedom in designing the compositions and properties of the first and second liquids is relatively higher than a liquid such as ink used in conventional ink jet recording methods. In addition, because the first and second liquids are used in combination with each other to form an image, even if characteristics other than a ICB are unsatisfactory when only one liquid is used, the combination of both liquids makes it possible to solve such a problem. For this reason, the ink jet recording method of the invention makes it relatively easy to satisfy the requirements for a ICB and for other characteristics (for example, optical density, a feathering, drying time and long-term reliability) simultaneously at high levels.

In the ink jet recording method of the invention, although no particular limitation is imposed on the contact angle (hereinafter abbreviated as “contact angle θ1” in some cases) of plain paper with the second liquid insofar as it is less than 85°, it is preferably less than 80° and more preferably less than 75°.

When the contact angle θ1 is 85° or more, the time required for drying the part of a recording medium that is printed using the second liquid alone becomes longer. Further, in the case of providing the second liquid so as to be in contact with the region where the first liquid has been provided on the recording medium during printing, the time required for drying becomes even longer.

It is to be noted that a smaller contact angle θ1 is better. However, the contact angle θ1 is preferably 10° or more in practice in view of limitation with regard to materials constituting the second liquid.

It is to be noted that the plain paper in the invention indicates all plain paper, which is generally and widely used in a broad sense. However, the plain paper used to measure the contact angle explained in the above (1) and (2) means FX-P paper (manufactured by Fuji Xerox Co., Ltd.) selected as one example of these widely used plain papers.

The measurement of the contact angle of plain paper with the second liquid is made by dripping a fixed amount of the second liquid on FX-P paper (manufactured by Fuji Xerox Co., Ltd.) using a FIBRO 1100 DAT MK II (manufactured by FIBRO system). More specifically, 4.0 μl of the second liquid is set above the plain paper and then dripped onto the plain paper to measure a contact angle 0.04 seconds after it is dripped. In the case where the contact angle cannot be measured 0.04 seconds after the second liquid is dripped, the contact angle measured at a point just when the contact angle can be measured after the second liquid is dripped is used.

Also, in the ink jet recording method of the invention, although no particular limitation is imposed on the contact angle (hereinafter abbreviated as “contact angle θ2”) of the region where the first liquid is provided on the plain paper insofar as the contact angle is 60° or more, the contact angle θ2 is more preferably 70° or more and still more preferably 80° or more.

When the contact angleθ2 is less than 60°, a ICB arises because the second liquid tends to be spread in the direction of the paper plane.

Although a larger the contact angleθ2 is better, it is preferably 110° or less in practice in view of limitations with regard to materials constituting the first liquid.

In the invention, the measurement of the contact angle of the region where the first liquid has been provided to plain paper with the second liquid is made by dripping a fixed amount of the second liquid on FX-P paper (manufactured by Fuji Xerox Co., Ltd.) at a position where 5.0±0.5 g/m² Of the first liquid has been provided using a FIBRO 1100 DAT MK II (manufactured by FIBRO system) one minute after the first liquid is provided. More specifically, 4.0 μl of the second liquid is set above the plain paper at the position where the first liquid has been provided and then dripped on the region where the first liquid has been provided to measure a contact angle 0.04 seconds after it is dripped. In the case where the contact angle cannot be measured 0.04 seconds after the second liquid is dripped, the contact angle measured at a point just when the contact angle can be measured after the second liquid is dripped is used.

In the meantime, a contact angle of a recording medium with a liquid is generally determined by factors such as a surface tension and viscosity of the liquid. Therefore, the contact angle θ1 is determined by the surface tension, viscosity of the second liquid and the like. Because these properties are governed by the composition of the second liquid, it is necessary to control the types and amounts of a surfactant, a solvent and the like to be added to the second liquid.

Also, the contact angle θ2 is determined by the state of the first liquid component on the surface of the recording medium, the surface tension and viscosity of the second liquid and the like. Therefore, in order to control the contact angle θ2, it is necessary to control each composition of the first and second liquids: such as, the types and amounts of the surfactant, the solvent and the like.

From the above viewpoints, the first liquid preferably contains at least one additive selected from a silicone type compound and a fluorine type compound. Because these compounds have the effect of heightening the water repellency of the region where the first liquid is provided on the recording medium, these compounds efficiently prevent the second liquid from spreading in the direction of the surface of paper when the second liquid is provided on the region, whereby the effect of preventing a ICB can be heightened. On the other hand, in the case where the first liquid does not contain these compounds, the effect of preventing the ICB can be insufficiently obtained. It is preferable that the silicone type compound is a silicone type surfactant and the fluorine type compound is a fluorine type surfactant.

Also, the weight average molecular weight of the silicone type compound or fluorine type compound is preferably 3,000 or more and more preferably 5,000 or more. When the weight average molecular weight is less than 3,000, only an insufficient water-repellent effect is produced, and therefore the ICB cannot be prevented.

Also, an acid value of the silicone type compound or fluorine type compound is preferably 30 mg KOH/g or more and 250 mg KOH/g or less, and more preferably 50 mg KOH/g or more and 200 mg KOH/g or less.

When the acid value is less than 30 mg KOH/g, the silicone type compound or fluorine type compound may be insufficiently dissolved in the first liquid, causing reduced jetting ability when the fist liquid is jetted from a recording head. On the other hand, when the acid value exceeds 250 mg KOH/g, the water solubility of these compounds is high, and there are therefore cases where the contact angles fulfilling the above requirements (1) and (2) are not obtained and the ICB is impaired.

As the silicone type compound, silicone oil, silicone type resins and a silicone type emulsion obtained by dispersing these compounds using a dispersant or the like may be utilized besides silicone type surfactants which will be described later.

Further, as the fluorine type compound, aqueous fluorine resins and a fluorine type emulsion obtained by dispersing these compounds using a dispersant or the like may be utilized besides fluorine type surfactants which will be described later.

The formation of an image by the ink jet recording method of the invention is accomplished at least by providing the first liquid on a recording medium and by providing the second liquid to the region where the first liquid is provided on the recording medium. Of course, an image formed by a method other than the above method may be formed on the recording medium insofar as an image formed by the above method is included.

As the recording medium used at this time, besides plain paper, such as FX-P paper and the like, which is generally commercially available, recording media (for example, paper dedicated for ink jet printing, gloss paper and ink jet films) other than such plain paper may be utilized. It is preferable to use plain paper among these recording media from the viewpoint of the high effect of color-edge definition.

In the invention, “the second liquid is provided so as to be in contact with the region where the first liquid is provided on the recording medium” means that the region where the first liquid is provided and the region where the second liquid is provided overlap each other and/or are adjacent to each other in the direction of the plane of the recording medium.

Two or more of each of the first and second liquids may be used. In this case, it is only required that at least one second liquid be provided so as to be in contact with the region where at least one first liquid is provided on the recording medium. Other liquids (no particular limitation is imposed on whether or not these liquids have the same properties and composition as the first liquid or the second liquid) may be further provided on the recording medium as needed after the first and second liquids are provided.

The first and second liquids may be provided either continuously or non-continuously. When the first and second liquids are provided continuously, the two may be provided continuously on the recording medium by using an ink jet recording device provided with at least a recording head which can jet two or more liquids from separate nozzle. Alternatively, when the two are provided non-continuously, for example, enough time may be allowed to pass in minute or day units after the first liquid is provided to the recording medium, and then the second liquid may be provided so as to be in contact with the region where the first liquid is provided.

No particular limitation is imposed on the first and second liquids used in the invention insofar as at least either one of the two contains a colorant. Also, as mentioned above, it is preferable that the first liquid contain a silicone type compound and/or a fluorine type compound. Specifically, each liquid preferably contains the following composition.

Namely, the first liquid preferably contains at least a water-soluble solvent, a surfactant and water and may further contain a colorant. Here, the surfactant contained in the first liquid may be a fluorine type surfactant or a silicone type surfactant. Further, the second liquid preferably contains at least a colorant, a water-soluble solvent and water.

No particular limitation is imposed on the colors of the first and second liquids. However, when the first liquid contains no colorant, the first liquid is preferably transparent, whereas when the first liquid contains a colorant, the first liquid is preferably colored (a chromatic color other than a black color). On the other hand, when the second liquid contains a colorant, the second liquid preferably has a black color. Also, as to a combination of the first and second liquids, it is practically preferable that the former is color ink and the latter is black ink. Also, the colorant contained in the first liquid is preferably a dye.

It is preferable that the colorant contained in the second liquid be a pigment and the pigment be at least one pigment selected from the group consisting of pigments dispersible in the second liquid by combining a polymer dispersant, self-dispersible pigments and pigments coated with a resin.

Also, in the invention, the number of coarse particles having an average particle diameter of 0.5 μm or more contained in a mixed solution in which the first and second liquids are mixed with each other is preferably 100,000/μL or less, more preferably 75,000/μL or less, and still more preferably 50,000/μL or less. When the number of coarse particles having an average particle diameter of 0.5 μm or more contained in a mixed solution in which the first and second liquids are mixed with each other exceeds 100,000/μL, long-term reliability may be deteriorated.

The number of coarse particles having an average particle diameter of 0.5 μm or less contained in a mixed solution in which the first and second liquids are mixed with each other is found by mixing these two liquids in a ratio of 1:1 and by sampling 2 μL of the mixed solution with stirring to carry out measurement using an Accusizer 770 Optical Particle Sizer (trade name, manufactured by Particle Sizing Systems). At this time, as to a measuring parameter, the density of the pigment is used as the density of dispersed particles. The density of this pigment may be found by measuring a pigment powder obtained by heating and drying a pigment dispersion solution by using a gravimeter, a pycnometer or the like.

The surface tension of the first liquid is preferably 15 mN/m or more and 45 mN/m or less, more preferably 19 mN/m or more and 39 mN/m or less, and still more preferably 20 mN/m or more and 30 mN/m or less.

When the surface tension is less than 15 mN/m, ink overflows on the surface of a nozzle, and there are therefore cases where printing cannot be carried out normally. On the other hand, when the surface tension exceeds 45 mN/m, the rate of penetration is reduced; whereby, the drying time may become longer.

On the other hand, the surface tension of the second liquid is preferably 15 mN/m or more and 60 mN/m or less, more preferably 15 mN/m or more and 45 mN/m or less, and still more preferably 15 mN/m or more and 35 mN/m or less.

When the surface tension is less than 15 mN/m, ink overflows on the surface of a nozzle, and there are therefore cases where printing cannot be carried out normally. On the other hand, when the surface tension exceeds 60 mN/m, the rate of penetration is reduced; whereby, the drying time may become longer.

Moreover, the surface tension of the first liquid is preferably smaller than that of the second liquid. When the surface tension of the first liquid is larger than that of the second liquid, the ICB becomes worse.

The viscosities of the first and second liquids are each preferably 1.2 mPa·s or more and 6.0 mPa·s or less, more preferably 1.5 mPa·s or more and less than 4.5 mPa·s, and still more preferably 1.8 mPa·s or more and less than 4.0 mPa·s.

When the viscosities of either of the first and second liquids are larger than 6.0 mPa·s, jetting ability may be deteriorated. When the viscosities of either of the first and second liquids are less than 1.2 mPa·s, long-term reliability may be deteriorated.

In the ink jet recording method of the invention, the first liquid and/or the second liquid may be provided on a recording medium in a liquid droplet state. At this time, the weight of the liquid per droplet (1 drop) is preferably 25 ng or less, more preferably 0.5 ng or more and 20 ng or less, and still more preferably 2 ng or more and 8 ng or less. As a method of providing the liquid in a liquid droplet state, a thermal ink jet system, piezo ink jet system or the like, which will be explained later, may be utilized. In the ink jet recording method of the invention, the first liquid is preferably provided on a recording medium by utilizing one system selected from a thermal ink jet system and a piezo ink jet system, and the second liquid is provided so as to be in contact with the region where the first liquid has been provided on the recording medium, to thereby form an image.

When the mass of the ink per drop exceeds 25 ng, the feathering may be deteriorated. The reason for this is considered to be that the contact angle of the recording medium with each of the first and second liquids varies depending on the amount of a drop and the liquid droplet tends to spread easily in the direction of the plane of paper.

However, in an ink jet device capable of jetting plural volumetric drops from one nozzle, the amount of a printable minimum drop is used as the above amount of the drop.

Although it is not always necessary to provide the first and second liquids in the form of liquid droplets on a recording medium, it is preferable that at least the second liquid be provided to the recording medium in the form of liquid droplets when at least the second liquid contains a colorant. At this time, the first liquid may be provided on the recording medium by any method and in any form such as a liquid droplet. For example, the recording medium may be immersed in the first liquid in advance to thereby provide the first liquid on the recording medium.

A thermal ink jet recording system or a piezo ink jet recording system is preferably adopted as a method of providing the first liquid and/or the second liquid from the viewpoint of the effect of improving the feathering and the ICB.

The reason for this has not been clarified. In the case of a thermal ink jet recording system, ink is heated to have low viscosity when jetted. However, since the temperature of the ink is reduced on the recording medium, the viscosity is sharply raised. This is considered to be effective to improve the feathering and the ICB. On the other hand, in the case of a piezo ink jet system, it is possible to jet a highly viscous liquid. It is inferred that since such a highly viscous liquid makes it possible to restrict the spread thereof in the direction of the plane of paper on the recording medium, this system has the effect of improving the feathering and the ICB.

First Liquid and Second Liquid

Next, various materials contained in the first and second liquids used in the invention will be explained.

In the invention, a pigment and a dye may both be used. As the pigment used in the invention, an organic pigment and an inorganic pigment may both be used as a colorant. Examples of a black pigment include carbon black pigments such as furnace black, lamp black, acetylene black and channel black.

Besides black pigments and pigments having the three primary colors (cyan, magenta and yellow), pigments having specific colors such as red, green, blue, brown and white, pigments having metal gloss such as gold and silver, non-colored or pale colored extender pigments, plastic pigments and the like may also be used. Pigments newly synthesized for the invention may also be used without any problem.

Specific examples of these pigments include but are not limited to, Raven 7000, Raven 5750, Raven 5250, Raven 5000 ULTRA II, Raven 3500, Raven 2000, Raven 1500, Raven 1250, Raven 1200, Raven 1190 ULTRA II, Raven 1170, Raven 1255, Raven 1080 and Raven 1060 (the above products are manufactured by Columbia Carbon) Regal 400R, Regal 330R, Regal 660R, Mogul L, Black Pearls L, Monarch 700, Monarch 800, Monarch 880, Monarch 900, Monarch 1000, Monarch 1100, Monarch 1300 and Monarch 1400 (the above products are manufactured by Cabot Corporation), Color Black FW1, Color Black FW2, Color Black FW2V, Color Black 18, Color Black FW200, Color Black S150, Color Black S160, Color Black S170, Printex 35, Printex U, Printex V, Printex 140U, Printex 140V, Special Black 6, Special Black 5, Special Black 4A and Special Black 4 (the above products are manufactured by Degussa), No. 25, No. 33, No. 40, No. 47, No. 52, No. 900, No. 2300, MCF-88, MA 600, MA 7, MA 8 and MA 100 (the above products are manufactured by Mitsubishi Chemical Co., Ltd.).

Examples of cyan color pigments include but are not limited to, C.I. Pigment Blue-1, -2, -3, -15, -15:1, -15:2, -15:3, -15:4, -16, -22 and -60.

Examples of magenta color pigments include but are not limited to, C.I. Pigment Red -5, -7, -12, -48, -48:1, -57, -112, -122, -123, -146, -168, -184 and -202.

Examples of yellow color pigments include but are not limited to, C.I. Pigment Yellow -1, -2, -3, -12, -13, -14, -16, -17, -73, -74, -75, -83, -93, -95, -97, -98, -114, -128, -129, -138, -151, -154 and -180.

Also, a pigment self-dispersible in water may be used as the pigment in the invention. The pigment self-dispersible in water indicates pigments, which have many water-soluble groups on the surface thereof and are stably dispersible in water even if a polymer dispersant, as will be described later, is not present. Specifically, a regular so-called pigment is subjected to surface reforming treatments such as acid/base treatment, coupling agent treatment, polymer graft treatment, plasma treatment and oxidation/reducing treatment to thereby obtain a pigment dispersible in water.

Also, as the pigments self-dispersible in water, besides pigments obtained by processing the above pigments by surface reforming treatments, commercially available self-dispersible pigments such as Cab-o-jet-200, Cab-o-jet-300, IJX-253, IJX-266, IJX-273, IJX-444 and IJX-55 manufactured by Cabot Corporation, and Microjet Black CW-1 and CW-2 manufactured by Orient Chemical Industries, Ltd. may also be used.

When a pigment self-dispersible in water is used as the pigment, a polymer material may be added in the ink.

Moreover, a pigment coated with a resin or the like may be used as the colorant. This is called a microcapsule pigment, and not only commercially available microcapsule pigments manufactured by Dainippon Ink and Chemicals, Incorporated and Toyo Ink MFG. Co., Ltd., but also microcapsule pigments produced experimentally and the like for the invention may be used.

The dye used in the invention may be either of a water-soluble dye and a disperse dye. Specific examples of the water-soluble dye include C.I. Direct Black -2, -4, -9, -11, -19, -22, -32, -80, -151, -154, -168, -171, -194 and -195, C.I. Direct Blue -1, -2, -6, -8, -22, -34, -70, -71, -76, -78, -86, -112, -142, -165, -199, -200, -201, -202, -203, -207, -218, -236, -287 and -307, C.I. Direct Red -1, -2, -4, -8, -9, -11, -13, -15, -20, -28, -31, -33, -37, -39, -51, -59, -62, -63, -73, -75, -80, -81, -83, -87, -90, -94, -95, -99, -101, -110, -189 and -227, C.I. Direct Yellow -1, -2, -4, -8, -11, -12, -26, -27, -28, -33, -34, -41, -44, -48, -58, -86, -87, -88, -132, -135, -142, -144 and -173, C.I. Food Black -1 and -2, C.I. Acid Black -1, -2, -7, -16, -24, -26, -28, -31, -48, -52, -63, -107, -112, -118, -119, -121, -156, -172, -194 and -208, C.I. Acid Blue -1, -7, -9, -15, -22, -23, -27, -29, -40, -43, -55, -59, -62, -78, -80, -81, -83, -90, -102, -104, -111, -185, -249 and -254, C.I. Acid Red -1, -4, -8, -13, -14, -15, -18, -21, -26, -35, -37, -52, -110, -144, -180, -249, -257 and -289, C.I. Acid Yellow -1, -3, -4, -7, -11, -12, -13, -14, -18, -19, -23, -25, -34, -38, -41, -42, -44, -53, -55, -61, -71, -76, -78, -79 and -122.

Specific examples of the disperse dye include C.I. Disperse Yellow -3, -5, -7, -8, -42, -54, -64, -79, -82, -83, -93, -100, -119, -122, -126, -160, -184:1, -186, -198, -204 and -224, C.I. Disperse Orange -13, -29, -31:1, -33, -49, -54, -66, -73, -119 and -163, C.I. Disperse Red -1, -4, -11, -17, -19, -54, -60, -72, -73, -86, -92, -93, -126, -127, -135, -145, -154, -164, -167:1, -177, -181, -207, -239, -240, -258, -278, -283, -343, -348, -356 and -362, C.I. Disperse Violet -33, C.I. Disperse Blue -14, -26, -56, -60, -73, -87, -128, -143, -154, -165, -165:1, -176, -183, -185, -201, -214, -224, -257, -287, -354, -365 and -368 and C.I. Disperse Green -6:1 and -9.

The colorant used in the invention is used in a range from 0.5 to 20% by mass and preferably 1 to 10% by mass based on the mass of the ink. When the amount of the colorant in the ink is less than 0.5% by mass, only insufficient optical density may be obtained, whereas when the amount of the colorant exceeds 20% by mass, the jetting ability of the ink may become unstable.

In the invention, a polymer dispersant may be used to disperse a pigment as the colorant in the first liquid and/or the second liquid. Meanwhile, as an additive in the case of using a pigment dispersible in water, a polymer dispersant may be added. As the polymer dispersant, a nonionic compound, anionic compound, cationic compound or amphoteric compound may be used, and for example, a copolymer of a monomer having an α, β-ethylenic unsaturated group may be used.

Specific examples of the monomer having an α, β-ethylenic unsaturated group include acrylic acid, methacrylic acid, crotonic acid, itaconic acid, itaconic acid monoester, maleic acid, maleic acid monoester, fumaric acid, fumaric acid monoester, vinylsulfonic acid, styrenesulfonic acid, sulfonated vinylnaphthalene, vinyl alcohol, acrylamide, methacryloxyethyl phosphate, bismethacryloxyethyl phosphate, methacryloxyethylphenyl acid phosphate, ethylene glycol dimethacrylate, diethylene glycol dimethacrylate, styrene, α-methylstyrene, styrene derivatives such as vinyltoluene, vinylcyclohexane, vinylnaphthalene, vinylnaphthalene derivatives, alkyl acrylate, phenyl acrylate, alkyl methacrylate, phenyl methacrylate, cycloalkyl methacrylate, alkyl crotonate, dialkyl itaconate and dialkyl maleate.

A homopolymer obtained by polymerizing the above monomer having an α, β-ethylenic unsaturated group or a copolymer obtained by copolymerizing two or more of the above monomers may be used as the polymer dispersant. Specific examples of these polymers or copolymers include polyvinyl alcohol, polyvinylpyrrolidone, styrene/styrenesulfonic acid copolymer, styrene/maleic acid copolymer, styrene/methacrylic acid copolymer, styrene/acrylic acid copolymer, vinylnaphthalene/maleic acid copolymer, vinylnaphthalene/methacrylic acid copolymer, vinylnaphthalene/acrylic acid copolymer, alkyl acrylate/acrylic acid copolymer, alkyl methacrylate/methacrylic acid copolymer styrene/alkylmethacrylate/methacrylic acid copolymer, styrene/alkylacrylate/acrylic acid copolymer, styrene/phenylmethacrylate/methacrylic acid copolymer and styrene/cyclohexylmethacrylate/methacrylic acid copolymer.

The polymer dispersant used in the invention preferably has a mass average molecular weight in a range from 200° to 1500°. When the molecular weight of the polymer dispersant is less than 2000, the pigment may not be dispersed stably, whereas when the molecular weight exceeds 15000, the viscosity of the ink may be higher, and the jetting ability may be therefore impaired. The mass average molecular weight is more preferably in a range from 3500 to 10000.

The polymer dispersant added in the ink is used in an amount in a range from 0.1 to 3% by mass. When the amount of the polymer dispersant to be added exceeds 3% by mass, the viscosity of the ink is increased, and therefore the jetting ability of the ink may be unstable. On the other hand, when the amount of the polymer dispersant to be added is less than 0.1% by mass, the dispersion stability of the pigment may be deteriorated. The amount of the polymer dispersant to be added is preferably 0.15 to 2.5% by mass and more preferably 0.2 to 2% by mass.

As the water-soluble organic solvent used in the invention, polyhydric alcohols, polyhydric alcohol derivatives, nitrogen-containing solvents, alcohols and sulfur-containing solvents may be used.

Specific examples of the polyhydric alcohols include ethylene glycol, diethylene glycol, propylene glycol, butylene glycol, triethylene glycol, 1,5-pentanediol, 1,2,6-hexanetriol and glycerin.

Examples of the polyhydric alcohol derivatives include ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monobutyl ether, dipropylene glycol monobutyl ether and ethylene oxide adducts of diglycerin.

Examples of the nitrogen-containing solvent include pyrrolidone, N-methyl-2-pyrrolidone, cyclohexylpyrrolidone and triethanolamine. Examples of the alcohols include alcohols such as ethanol, isopropyl alcohol, butyl alcohol and benzyl alcohol.

Examples of the sulfur-containing solvent include thiodiethanol, thiodiglycerol, sulfolane and dimethyl sulfoxide. Besides the above, propylene carbonate, ethylene carbonate or the like may be used.

It is preferable that at least one or more types of the water-soluble organic solvent are used in the invention. The content of the water-soluble organic solvent in the ink to be used is 1 to 60% by mass and preferably 5 to 40% by mass. When the amount of the water-soluble organic solvent in the ink is less than 1% by mass, long-term reliability may be impaired. In contrast, when the amount of the water-soluble organic solvent in the ink is larger than 60% by mass, the viscosity of the liquid is increased, and therefore the jetting characteristics of the liquid may be unstable.

In the invention, for example, a compound having a structure provided with a hydrophilic part and a hydrophobic part together in its molecule may be efficiently used as the surfactant used in the first liquid. Besides a fluorine type surfactant and a silicone type surfactant, an anionic surfactant, cationic surfactant, amphoteric surfactant or nonionic surfactant may also be used. Moreover, a polymer dispersant may also be used.

As the fluorine type surfactant, a fluorine type surfactant such as a perfluoroalkyl carboxylate, perfluoroalkyl sulfonate, perfluoroalkylethylene oxide, a perfluoroalkylamine compound or perfluoroalkylbetaine is effectively used.

As the silicone type surfactant, a silicone type surfactant such as a polysiloxaneoxyethylene adduct is effectively used.

As the anionic surfactant, an alkylbenzene sulfonate, alkylphenyl sulfonate, alkylnaphthalene sulfonate, higher fatty acid salt, sulfate of higher fatty acid ester, sulfonate of higher fatty acid ester, sulfate and sulfonate of higher alcohol ether, higher alkyl sulfosuccinate, higher alkyl phosphate or phosphate of a higher alcohol ethylene oxide adduct may be used. For example, dodecylbenzene sulfonate, kerylbenzene sulfonate, isopropylnaphthalene sulfonate, monobutylphenylphenol monosulfonate, monobutylbiphenyl sulfonate, monobutylbiphenyl sulfonate and dibutylphenylphenol disulfonate may also be used effectively.

Examples of the nonionic surfactant include a polypropylene glycol ethylene oxide adduct, polyoxyethylene nonylphenyl ether, polyoxyethylene octylphenyl ether, polyoxyethylene dodecylphenyl ether, polyoxyethylene alkyl ether, polyoxyethylene fatty acid ester, sorbitan fatty acid ester, polyoxyethylenesorbitan fatty acid ester, fatty acid alkylolamide, acetylene glycol, an oxyethylene adduct of acetylene glycol, aliphatic alkanolamide, glycerin ester and sorbitan ester.

Examples of the cationic surfactant include a tetraalkylammonium salt, alkylamine salt, benzarconium salt, alkylpyridium salt and imidazolium salt. Examples of the cationic surfactant include dihydroxyethylstearylamine, 2-heptadecenyl-hydroxyethylimidazoline, lauryldimethylbenzylammonium chloride, cetylpyridinium chloride and stearamidomethylpyridium chloride.

Other than the above, biosurfactants such as spiculisporic acid, ramnolipid and lysolecithin may also be used.

When a surfactant is added to the first liquid in the invention, this surfactant preferably has high hydrophobic characteristics or a high molecular weight. Also, the hydrophobic characteristics of the surfactant are preferably controlled based on the HLB value, SP value, acid value and the like such that the contact angle θ2 falls in the foregoing range.

When the surfactant is added to the first liquid, the amount of the surfactant to be added to the first liquid is preferably less than 10% by mass, more preferably in a range from 0.01 to 5% by mass, and still more preferably in a range from 0.01 to 3% by mass. When the amount to be added exceeds 10% by mass, optical density and the preservation stability of the pigment ink may be impaired.

As mentioned above, the first liquid preferably contains a fluorine type compound and/or a silicone type compound, whereas it is preferable that the second liquid does not contain a fluorine type compound and a silicone compound. When at least one of a fluorine type compound or a silicone compound is contained in the second liquid, the ICB tends to become worse.

Also, the first liquid may contain a compound (coagulant) having the ability to coagulate the components contained in the second liquid.

When, for example, the second liquid contains a colorant provided with an anionic group on the surface thereof, the first liquid preferably contains an electrolyte and/or a cationic compound. Examples of the electrolyte which is effectively used in the invention include alkali metal ions such as a lithium ion, sodium ion and potassium ion, polyvalent metal ions such as an aluminum ion, barium ion, calcium ion, copper ion, iron ions, magnesium ions, manganese ion, nickel ion, tin ions, titanium ion and zinc ion, hydrochloric acid, hydrobromic acid, hydroiodic acid, sulfuric acid, nitric acid, phosphoric acid, thiocyanic acid, organic carboxylic acids such as acetic acid, oxalic acid, lactic acid, fumaric acid, citric acid, salicylic acid and benzoic acid, salts of organic sulfonates, and the like.

Specific examples include salts of alkali metals such as lithium chloride, sodium chloride, potassium chloride, sodium bromide, potassium bromide, sodium iodide, potassium iodide, sodium sulfate, potassium nitrate, sodium acetate, potassium oxalate, sodium citrate and potassium benzoate, and salts of polyvalent metals such as aluminum chloride, aluminum bromide, aluminum sulfate, aluminum nitrate, sodium aluminum sulfate, potassium aluminum sulfate, aluminum acetate, barium chloride, barium bromide, barium iodide, barium oxide, barium nitrate, barium thiocyanate, calcium chloride, calcium bromide, calcium iodide, calcium nitrite, calcium nitrate, calcium dihydrogenphosphate, calcium thiocyanate, calcium benzoate, calcium acetate, calcium salicylate, calcium tartarate, calcium lactate, calcium fumarate, calcium citrate, copper chloride, copper bromide, copper sulfate, copper nitrate, copper acetate, iron chloride, iron bromide, iron iodide, iron sulfate, iron nitrate, iron oxalate, iron lactate, iron fumarate, iron citrate, magnesium chloride, magnesium bromide, magnesium iodide, magnesium sulfate, magnesium nitrate, magnesium acetate, magnesium lactate, manganese chloride, manganese sulfate, manganese nitrate, manganese dihydrogenphosphate, manganese acetate, manganese salicylate, manganese benzoate, manganese lactate, nickel chloride, nickel bromide, nickel sulfate, nickel nitrate, nickel acetate, tin sulfate, titanium chloride, zinc chloride, zinc bromide, zinc sulfate, zinc nitrate, zinc thiocyanate and zinc acetate.

Examples of the cationic compound include primary, secondary, tertiary and quaternary amines and their salts. Specific examples of the cationic surfactant include tetraalkylammonium salts, alkylamine salts, benzalkonium salts, alkylpyridium salts, imidazolium salts and polyamines, which include, isopropylamine, isobutylamine, t-butylamine, 2-ethylhexylamine, nonylamine, dipropylamine, diethylamine, trimethylamine, triethylamine, dimethylpropylamine, ethylenediamine, propylenediamine, hexamethylenediamine, diethylenetriamine, tetraethylenepentamine, diethanolamine, diethylethanolamine, triethanolamine, tetramethylammonium chloride, tetraethylammonium bromide, dihydroxyethylstearylamine, 2-heptadecenyl-hydroxyethylimidazoline, lauryldimethylbenzylammonium chloride, cetylpyridinium chloride, stearamidemethylpyridium chloride, diallyldimethylammonium chloride polymers, diallylamine polymers and monoallylamine polymers.

Preferable examples of the electrolyte include aluminum sulfate, calcium chloride, calcium nitrate, calcium acetate, magnesium chloride, magnesium nitrate, magnesium sulfate, magnesium acetate, tin sulfate, zinc chloride, zinc nitrate, zinc sulfate, zinc acetate, ammonium nitrate, monoallylamine polymers, diallylamine polymers and diallyldimethylammonium chloride polymers.

When the second liquid contains a colorant having a cationic group on the surface thereof, the first liquid preferably contains an anionic compound.

Examples of the anionic compound used effectively in the invention include organic carboxylic acids, organic sulfonic acids and salts of these acids. Specific examples of the organic carboxylic acid include acetic acid, oxalic acid, lactic acid, fumaric acid, citric acid, salicylic acid and benzoic acid. Oligomers and polymers having more than one of these basic structures may be used without any problem. Further, examples of the organic sulfonic acid include compounds such as benzenesulfonic acid and toluenesulfonic acid. Oligomers and polymers having more than one of these basic structures may be used without any problem.

The above listed coagulants to be added to the first liquid may be used either singly or by mixing two or more. The content of the coagulant to be added to the first liquid is 0.1 to 15% by mass and preferably 0.5 to 10% by mass.

Besides the above ingredients, polyethyleneimine, polyamines, polyvinylpyrrolidone, polyethylene glycol, cellulose derivatives such as ethyl cellulose and carboxymethyl cellulose, polysaccharides and their derivatives, other water-soluble polymers, polymer emulsions such as acrylic polymer emulsions and polyurethane type emulsions, cyclodextrin, large ring amines, dendorimers, crown ethers, urea and its derivatives, and acetamide may be used for the purpose of controlling characteristics, such as, improving jetting characteristics.

Also, compounds of alkali metals such as potassium hydroxide, sodium hydroxide and lithium oxide, nitrogen-containing compounds such as ammonium hydroxide triethanolamine, diethanolamine, ethanolamine and 2-amino-2-methyl-1-propanol, compounds of alkali earth metals such as calcium hydroxide, acids such as sulfuric acid, hydrochloric acid and nitric acid, and salts of strong acids and weak alkalis such as ammonium sulfate may be used to regulate conductivity and pH.

Other than the above, pH buffers, antioxidants, mildew-proofing agents, viscosity regulators, conductive agents, ultraviolet absorbers, chelating agents and the like may be added as necessary.

<Ink Jet Recording Device>

Next, the ink jet recording device of the invention will be explained. There are no particular limitations with regard to the ink jet recording device of the invention insofar as it forms an image by utilizing the ink jet recording method of the invention as mentioned above. However, specifically, the device is preferably one such as will be explained below.

Specifically, the ink jet recording device of the invention includes an ink jet recording device comprising: a recording head provided with two or more nozzles respectively jetting two or more liquids respectively onto a surface of a recording medium, the device using a first liquid and a second liquid as the two or more liquids, wherein: at least one of the first and second liquids contains a colorant; an image is formed at least by jetting the first liquid from the recording head onto the recording medium and jetting the second liquid from the recording head so as to be in contact with a region where the first liquid has been provided on the recording medium; a contact angle of the second liquid with respect to plain paper is less than 85°; and a contact angle of the second liquid with respect to the region where the first liquid is provided on the plain paper is 60° or more.

Accordingly, the use of the ink jet recording device of the invention makes it possible to prevent ICB. Also, for reasons such as described above, the ink jet recording device of the invention can relatively easily satisfy not only the requirements for the ICB, but also the requirements for other characteristics (for example, optical density, feathering, drying time and long-term reliability) at high levels.

The ink jet recording device of the invention may, of course, be provided as necessary with known members and mechanisms other than the aforementioned recording head. For example, the device may be provided with a heater that controls the drying of ink and the like, or may be provided with an intermediate transfer mechanism that transfers a recording material to a recording medium such as paper after the recording material is printed on an intermediate body.

### EXAMPLES

The present invention will be explained in more detail by way of examples. However, these examples are not intended to limit the invention. The liquids A to P used in each example and comparative example are manufactured by the pigment treating method (in the case of using a surface treated pigment) and the liquid producing method explained below.

Pigment Treating Method

A pigment is subjected to surface oxidation treatment using sodium hypochlorite and then to desalting treatment. The surface treated pigment thus obtained is added in ion exchange water so that a concentration of the pigment in the resulting solution is 20% by mass. After the solution is adjusted to pH 7.5, it is dispersed using an ultrasonic homogenizer. This dispersion solution is subjected to centrifugation (8000 rpm×30 minutes) using a centrifugal separator to remove a residual part (20% by mass based on the total amount).

Liquid Producing Method

A colorant solution, a water-soluble organic solvent, a surfactant, ion exchange water and the like are added in proper amounts so as to have a predetermined composition, and the mixed solution is mixed and stirred. The resulting liquid is passed through a 1 μm filter to obtain a desired liquid.

<Liquid A>

Cabojet-300 (self-dispersible pigment, manufactured by Cabot Corporation): 4.5% by mass

Styrene/acrylic acid/sodium acrylate copolymer: 0.3% by mass

Diethylene glycol: 10% by mass

Glycerin: 10% by mass

Urea: 4.5% by mass

Surfactant (acetylene glycol ethylene oxide adduct) (Surfynol 465, manufactured by Nisshin Chemicals Co., Ltd.): 0.7% by mass

Ion exchange water: 70% by mass

This ink has a viscosity of 2.1 mPa·s and a surface tension of 32 mN/m.

<Liquid B>

IJK 444 (self-dispersible pigment, manufactured by Cabot Corporation): 4% by mass

Styrene/acrylic acid/sodium acrylate copolymer: 0.15% by mass

Diethylene glycol: 10% by mass

Propylene glycol: 5% by mass

Sulfolane: 5% by mass

Urea: 3% by mass

Surfactant (acetylene glycol ethylene oxide adduct) (Surfynol 465, manufactured by Nisshin Chemicals Co., Ltd.): 0.8% by mass

Fluorine type surfactant (perfluoroalkylethylene oxide adduct) (Unidyn DS-401, manufactured by Daikin Industries, Ltd.): 0.3% by mass

Ion exchange water: 71.75% by mass

This ink has a viscosity of 2.3 mPa·s and a surface tension of 18 mN/m.

<Liquid C>

A pigment treated according to the pigment treating method is made into ink by a predetermined method.

C.I. Pigment Blue 15:3 (surface-treated): 2.5% by mass

Styrene/acrylic acid/sodium acrylate copolymer: 0.15% by mass

Diethylene glycol: 15% by mass

Diethylene glycol monobutyl ether: 5% by mass

Urea: 5% by mass

Surfactant (acetylene glycol ethylene oxide adduct) (Surfynol 465, manufactured by Nisshin Chemicals Co., Ltd.): 0.3% by mass

Fluorine type surfactant (perfluoroalkylethylene oxide adduct) (Unidyn DS-401, manufactured by Daikin Industries, Ltd.): 0.5% by mass

Ion exchange water: 71.55% by mass

This ink has a viscosity of 2.1 mPa·s and a surface tension of 18 mN/m.

<Liquid D>

A pigment treated according to the pigment treating method is made into ink by a predetermined method.

C.I. Pigment Red 122 (surface-treated): 5% by mass

Styrene/acrylic acid/sodium acrylate copolymer: 0.15% by mass

Diethylene glycol: 15% by mass

Diethylene glycol monobutyl ether: 5% by mass

Urea: 3% by mass

Surfactant (acetylene glycol ethylene oxide adduct) (Surfynol 465, manufactured by Nisshin Chemicals Co., Ltd.): 0.5% by mass

Fluorine type surfactant (perfluoroalkylethylene oxide adduct) (Unidyn DS-401, manufactured by Daikin Industries, Ltd.): 0.5% by mass

Ion exchange water: 70.85% by mass

This ink has a viscosity of 2.2 mPa·s and a surface tension of 18 mN/m.

<Liquid E>

Diethylene glycol: 20% by mass

Glycerin: 5% by mass

Urea: 6% by mass

Styrene-acrylic acid copolymer: 0.2% by mass

Polysiloxane-acrylic acid copolymer (mass average molecular weight: 5500/acid value: 80 mg KOH/g): 0.6% by mass

Ion exchange water: 68.2% by mass

This ink has a viscosity of 1.9 mPa·s and a surface tension of 26 mN/m.

<Liquid F>

C.I. Acid Blue 9: 3% by mass

Polysiloxane/acrylic acid/sodium acrylate copolymer: 0.4% by mass

Diethylene glycol: 10% by mass

1,5-pentanediol: 5% by mass

Butylcarbitol: 5% by mass

Surfactant (acetylene glycol ethylene oxide adduct) (Surfynol 465, manufactured by Nisshin Chemicals Co., Ltd.): 0.5% by mass

Silicone oil (methylhydrogenpolysiloxane) (KF 99, manufactured by Shin-Etsu Silicone Co., Ltd.): 0.1% by mass

N,N-Bis(2-hydroxyethyl)-2-aminoethanesulfonic acid: 1.2% by mass

Sodium hydroxide: 0.6% by mass

Urea: 2% by mass

Isopropyl alcohol: 3.5% by mass

Ion exchange water: 68.7% by mass

This ink has a viscosity of 2.3 mPa·s and a surface tension of 24 mN/m.

<Liquid G>

C.I. Acid Blue 9: 3.5% by mass

Diethylene glycol: 10% by mass

1,5-pentanediol: 5% by mass

Butylcarbitol: 5% by mass

Surfactant (acetylene glycol ethylene oxide adduct) (Surfynol 465, manufactured by Nisshin Chemicals Co., Ltd.): 0.5% by mass

N,N-Bis(2-hydroxyethyl)-2-aminoethanesulfonic acid: 1.2% by mass

Sodium hydroxide: 0.6% by mass

Urea: 2% by mass

Isopropyl alcohol: 3.5% by mass

Ion exchange water: 68.7% by mass

This ink has a viscosity of 2.3 mPa·s and a surface tension of 33 mN/m.

<Liquid H>

A pigment treated according to the pigment treating method is made into ink by a predetermined method.

C.I. Pigment Yellow 74 (surface-treated): 4% by mass

Diethylene glycol: 20% by mass

Surfactant (acetylene glycol ethylene oxide adducts) (Surfynol 465, manufactured by Nisshin Chemicals Co., Ltd.): 2% by mass

Urea: 2% by mass

Isopropyl alcohol: 3.5% by mass

Ion exchange water: 68.5% by mass

This ink has a viscosity of 2.0 mPa·s and a surface tension of 31 mN/m.

<Liquid I>

C.I. Acid Red 52: 3.5% by mass

Diethylene glycol: 10% by mass

1,5-pentanediol: 5% by mass

Butylcarbitol: 5% by mass

Surfactant (acetylene glycol ethylene oxide adduct) (Surfynol 465, manufactured by Nisshin Chemicals Co., Ltd.): 0.5% by mass

N,N-Bis(2-hydroxyethyl)-2-aminoethanesulfonic acid: 1.2% by mass

Sodium hydroxide: 0.6% by mass

Urea: 2% by mass

Isopropyl alcohol: 3.5% by mass

Ion exchange water: 68.7% by mass

This ink has a viscosity of 2.0 mPa·s and a surface tension of 31 mN/m.

<Liquid J>

Cabojet 200 (self-dispersible pigment, manufactured by Cabot Corporation): 4.5% by mass

Diethylene glycol: 20% by mass

Urea: 3% by mass

Ion exchange water: 72.5% by mass

This ink has a viscosity of 2.1 mPa·s and a surface tension of 53 mN/m.

<Liquid K>

Diethylene glycol: 15% by mass

Propylene glycol: 10% by mass

Urea: 4% by mass

Isopropyl alcohol: 3% by mass

Water: 68% by mass

This ink has a viscosity of 1.8 mPa·s and a surface tension of 55 mN/m.

<Liquid L>

Cabojet 300 (self-dispersible pigment, manufactured by Cabot Corporation): 5% by mass

Styrene/acrylic acid/sodium acrylate copolymer: 1.0% by mass

Diethylene glycol: 10% by mass

2-Pyrrolidone: 10% by mass

Glycerin: 5% by mass

Urea: 4.5% by mass

Surfactant (acetylene glycol ethylene oxide adduct) (Surfynol 465, manufactured by Nisshin Chemicals Co., Ltd.): 0.1% by mass

Ion exchange water: 64.4% by mass

This ink has a viscosity of 2.7 mPa·s and a surface tension of 32 mN/m.

<Liquid M>

Cabojet 300 (self-dispersible pigment, manufactured by Cabot Corporation): 4.5% by mass

Styrene/acrylic acid/sodium acrylate copolymer: 0.3% by mass

Diethylene glycol: 10% by mass

Propylene glycol: 10% by mass

Urea: 3% by mass

Ion exchange water: 72.2% by mass

This ink has a viscosity of 2.4 mPa·s and a surface tension of 34 mN/m.

<Liquid N>

Cabojet 300 (self-dispersible pigment, manufactured by Cabot Corporation): 4.5% by mass

Styrene/acrylic acid/sodium acrylate copolymer: 0.1% by mass

Diethylene glycol: 15% by mass

Propylene glycol: 5% by mass

Urea: 3% by mass

Ion exchange water: 72.4% by mass

This ink has a viscosity of 2.2 mPa·s and a surface tension of 36 mN/m.

<Liquid 0>

IJX 444 (self-dispersible pigment, manufactured by Cabot Corporation): 4% by mass

Styrene/acrylic acid/sodium acrylate copolymer: 0.15% by mass

Diethylene glycol: 20% by mass

Urea: 3% by mass

Surfactant (acetylene glycol ethylene oxide adduct) (Surfynol 465, manufactured by Nisshin Chemicals Co., Ltd.): 0.8% by mass

Fluorine type surfactant (perfluoroalkylethylene oxide adduct) (Unidyn DS-401, manufactured by Daikin Industries, Ltd.): 0.2% by mass

Ion exchange water: 71.85% by mass

This ink has a viscosity of 2.4 mPa·s and a surface tension of 18 mN/m.

<Liquid P>

Diethylene glycol: 15% by mass

Propylene glycol: 10% by mass

Urea: 4% by mass

Isopropyl alcohol: 3% by mass

Magnesium nitrate: 0.05% by mass

Surfactant (polyoxyethylene-2-ethylhexyl ether): 1% by mass

Water: 66.95% by mass

This ink has a viscosity of 1.7 mPa·s and a surface tension of 30 mN/m.

Evaluation

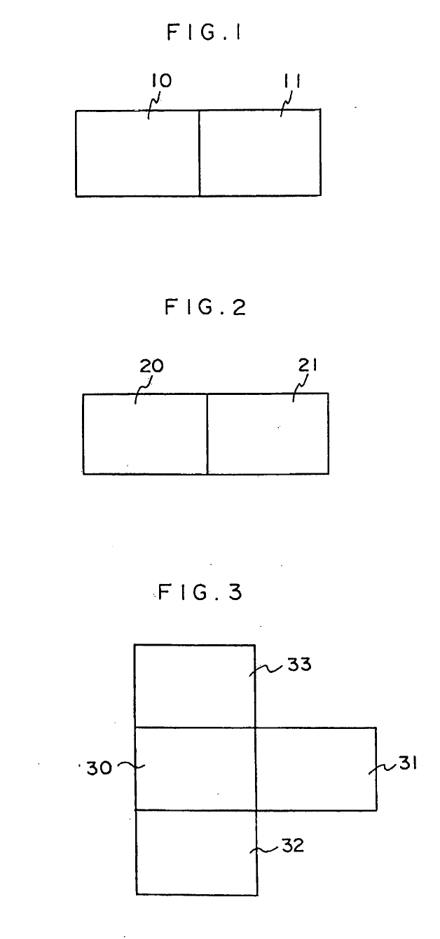

As to printing characteristics, an ink jet recording device provided with an experimental print head (800 dpi and 256 nozzles) is used to evaluate optical density, ICB, feathering, drying time and long-term reliability. As the recording medium, FX-P paper (manufactured by Fuji Xerox Co., Ltd.) is used. The optical density and the ICB are evaluated by rating images obtained by printing the print patterns A, B and C shown in FIGS. 1 to 3.

FIG. 1 is a schematic pattern diagram showing the print pattern A printed on paper. The print pattern A includes rectangular regions shown by the numerals 10 and 11, wherein the region 10 indicates a rectangular region where liquids 1 and 2 are provided and the region 11 indicates a rectangular region where the liquid 2 is provided, these regions 10 and 11 being respectively disposed such that one side of each region is adjacent to one side of the other. The print pattern A is printed by providing the liquid 2 to the regions 10 and 11 after the liquid 1 is provided to the region 10.

FIG. 2 is a schematic pattern diagram showing a print pattern B printed on paper. The print pattern B includes a rectangular region shown by the numerals 20 and 21, wherein the region 20 indicates a rectangular region where the liquid 1 is provided and the region 21 indicates a rectangular region where the liquid 2 is provided, these regions 20 and 21 being respectively disposed such that one side of each region is adjacent to one side of the other. The print pattern B is printed by providing the liquid 2 to the region 21 after the liquid 1 is provided to the region 20.

FIG. 3 is a schematic pattern diagram showing a print pattern C printed on paper. The print pattern C includes regions indicated by the rectangular symbols 30, 31, 32 and 33 respectively. The region 30 indicates a rectangular region where the liquids 1 and 2 are provided, the region 31 indicates a rectangular region where the liquid 2 is provided, the region 32 indicates a rectangular region where a liquid 3 is provided, and the region 33 indicates a rectangular region where the liquid 4 is provided. The regions 30 and 31 are disposed such that one side of each region is adjacent to one side of the other, and the regions 32 and 33 are disposed such that they are respectively adjacent to two opposite sides, of the region 30, which are perpendicular to the side of the region 30 which side is adjacent to the region 31. The print pattern C is printed by providing the liquid 1 to the region 30, by then providing the liquid 2 to the regions 30 and 31, by next providing the liquid 3 to the region 32, and by then providing the liquid 4 to the region 33.

It is to be noted that the liquid 1 used for the above print patterns A to C corresponds to the first liquid used in the invention and the liquid 2 corresponds to the second liquid used in the invention. Also, the liquids 1 to 4 used when printing the print patterns A to C are selected from the above liquids A to L.

The printing is carried out in an ordinary environment (temperature: 23±0.5° C., humidity: 55±5% R. H) and the evaluation is made using a sample allowed to stand under the ordinary environment for 24 hours after printing unless otherwise noted. The results are shown in Tables 1 and 2.

TABLE 1

| | | | | Contact | Contact | Results of evaluation | | | | |
|---|---|---|---|---|---|---|---|---|---|---|
| | Liquid 1 | Liquid 2 | Print | angle θ1 | angle θ2 | Optical | | | Drying | Long-term |
| | (first liquid) | (second liquid) | pattern | (deg) | (deg) | density | Feathering | ICB | time | reliability |
| Example 1 | B | A | A | 52 | 78 | A | A | A | A | A |
| Example 2 | C | A | B | 52 | 80 | B | B | A | A | A |
| Example 3 | E | A | A | 52 | 95 | A | A | A | A | A |
| Example 4 | F | A | A | 52 | 88 | A | A | A | A | A |
| Example 5 | B | M | A | 80 | 78 | A | A | A | B | A |
| Example 6 | O | A | A | 52 | 65 | A | B | B | A | A |
| Comparative | H | A | A | 52 | 35 | B | C | C | A | A |
| Example 1 | | | | | | | | | | |
| Comparative | I | A | A | 52 | 40 | B | C | C | A | A |
| Example 2 | | | | | | | | | | |
| Comparative | K | J | A | 100 | 38 | A | C | C | C | C |
| Example 3 | | | | | | | | | | |
| Comparative | H | N | A | 92 | 35 | A | C | C | C | A |
| Example 4 | | | | | | | | | | |
| Comparative | P | A | A | 52 | 56 | B | C | C | A | A |
| Example 5 | | | | | | | | | | |

TABLE 2

| | | | | | | Contact | Contact | Results of evaluation | | | | |
|---|---|---|---|---|---|---|---|---|---|---|---|---|
| | Liquid 1 | Liquid 2 | | | Print | angle θ1 | angle θ2 | Optical | | | Drying | Long-term |
| | (first liquid) | (second liquid) | Liquid 3 | Liquid 4 | pattern | (deg) | (deg) | density | Feathering | ICB | time | reliability |
| Example 7 | B | A | C | D | C | 52 | 78 | A | A | A | A | A |
| Example 8 | B | L | H | I | C | 82 | 78 | A | A | A | B | A |
| Compara- | G | A | H | I | C | 52 | 44 | B | C | C | A | A |
| tive Ex- | | | | | | | | | | | | |
| ample 9 | | | | | | | | | | | | |

The methods and standards for evaluating the optical density, feathering, ICB, drying time and long-term reliability shown in Tables 1 and 2 are as follows.

<Optical Density>

When images are formed according to each print pattern shown in FIGS. 1 to 3, respective optical densities in two regions on which the print pattern are printed using the liquids 1 and 2 are measured using an X-Rite 400 (manufactured by X-Rite Incorporated). In this case, when the results of evaluation in these two regions are different from each other, the results of evaluation of an inferior one between the two are shown in Tables 1 and 2.

Evaluation Standard (Black Ink)

A: Optical density: 1.4 or more.

B: Optical density: 1.3 or more and less than 1.4.

C: Optical density: less than 1.3.

Evaluation Standard (Color Ink)

A: Optical density: 1.1 or more.

B: Optical density: 1.0 or more and less than 1.1.

C: Optical density: less than 1.0.

<ICB>

The ICB is evaluated in such a manner that when the print patterns A to C shown in FIGS. 1 to 3 are printed, the degree of a loss of color-edge definition at the boundary between each region constituting the print pattern is compared with an allowance model defined in advance to evaluate functionally.

Evaluation Standard (Print Patterns A and B)

A: The ICB is small.

B: The ICB is observed but is at the allowance level.

C: The ICB is large and is outside the allowance level.

Evaluation Standard (Print Patterns C)

A: The ICB is small in all boundaries between the region 30 and the region 31, between the region 30 and the region 32, and between the region 30 and the region 33.

B: The ICB is observed at least at the boundary between the region 30 and the region 31 but is at the allowance level.

C: The ICB is large at least at the boundary between the region 30 and the region 31 and is outside the allowance level.

<Feathering>

The liquids 1 and 2 were respectively used to print a fine line patterns, and the degree of a loss of color-edge definition in the printed part is compared with an allowance model to evaluate functionally.

Standard of Evaluation

A: The feathering is small in the fine line pattern of the liquid 1 and the fine line pattern of the liquid 2.

B: The feathering is observed in at least one of the fine line pattern of the liquid 1 and the fine line pattern of the liquid 2 but is at the allowance level.

C: A bad feathering is observed in at least one of the fine line pattern of the liquid 1 and the fine line pattern of the liquid 2 and is outside the allowable range.

<Drying Time>

After a predetermined time passed after a 100% coverage pattern of each of the liquids 1 and 2 is printed on FX-P paper, another FX-P paper is applied to the print pattern under a load of 1.9×10⁴ N/m². At this time, the amount of time taken until ink is ceased to be transferred to the applied FX-P paper is defined as the drying time.

Standard of Evaluation

A: The drying time for each of the 100% coverage pattern of the liquid 1 and the 100% coverage pattern of the liquid 2 is less than 3 seconds.

B: The drying time for at least one of the 100% coverage pattern of the liquid 1 and the 100% coverage pattern of the liquid 2 is 3 seconds or more and less than 10 seconds.

C: The drying time for at least one of the 100% coverage pattern of the liquid 1 and the 100% coverage pattern of the liquid 2 is 10 seconds or more.

<Long-Term Reliability>

The long-term reliability is judged based on a change in the liquid jetting speed of each of the liquids 1 and 2. Specifically, the liquid jetting speed is measured in the initial stage. Thereafter, printing of 1×10⁸ pulses is carried out and then the liquid jetting speed is measured again. The ratio of the liquid jetting speed in the initial stage to the liquid jetting speed after the printing of 1×10⁸ pulses is carried out is calculated to evaluate the long-term reliability according to the following standard of evaluation.

Standard of Evaluation

A: The jetting speed after the printing of 1×10⁸ pulses is finished is 90% or more of the printing speed in the initial stage in the case of both of the liquids 1 and 2.

B: The jetting speed after the printing of 1×10⁸ pulses is finished is 75% or more and less than 90% of the printing speed in the initial stage in the case of at least one of the liquids 1 and 2.

C: The jetting speed after the printing of 1×10⁸ pulses is finished is less than 75% of the printing speed in the initial stage in the case of at least one of the liquids 1 and 2.

As explained above, the invention provides an ink jet recording method and an ink jet recording device, which can prevent ICB.

What is claimed is:

1. An ink jet recording method using a first liquid and a second liquid wherein at least one of the liquids contains a colorant, the method comprising: Providing the first liquid on a recording medium and providing the second liquid so as to be in contact with a region where the first liquid has been provided on the recording medium, to thereby form an image, wherein;
a contact angle of the second liquid with respect to plain paper is less than 85° and a contact angle of the second liquid with respect to region where the first liquid is provided on plain paper is 60° or more.

2. An ink jet recording method according to claim 1, wherein the first liquid contains at least one additive selected from the group consisting of a silicone type compound and a fluorine type compound.

3. An ink jet recording method according to claim 2, wherein the silicone type compound is a silicone type surfactant and the fluorine type compound is a fluorine type surfactant.

4. An ink jet recording method according to claim 2, wherein a weight average molecular weight of the silicone type compound or fluorine type compound is 3,000 or more.

5. An ink jet recording method according to claim 2, wherein an acid value of the silicone type compound or fluorine type compound is 30 mg KOH/g or more and 250 mg KOH/g or less.

6. An ink jet recording method according to claim 1, wherein the first liquid contains at least a water-soluble solvent, a surfactant and water, and the second liquid contains at least a colorant, a water-soluble solvent and water.

7. An ink jet recording method according to claim 6, wherein the first liquid contains a colorant.

8. An ink jet recording method according to claim 7, wherein the first liquid is color ink and the second liquid is black ink.

9. An ink jet recording method according to claim 8, wherein the colorant contained in the first liquid is a dye.

10. An ink jet recording method according to claim 6, wherein the colorant contained in the second liquid is a pigment, and the pigment is selected from the group consisting of a pigment dispersible in the second liquid by combining with a polymer dispersant, a self-dispersible pigment and a pigment coated with a resin.

11. An ink jet recording method according to claim 1, wherein a number of coarse particles having a particle diameter of 0.5 μm or more which are contained in a mixed solution prepared by mixing the first and second liquids is 100,000 μL or less.

12. An ink jet recording method according to claim 1, wherein a surface tension of the first liquid is 15 mN/m or more and 45 mN/m or less.

13. An ink jet recording method according to claim 1, wherein a surface tension of the second liquid is 15 mN/m or more and 60 mN/m or less.

14. An ink jet recording method according to claim 1, wherein the viscosity of each of the first and second liquids is 1.2 mPa·s or more and 6.0 mPa·s or less.

15. An ink jet recording method according to claim 1, wherein the first liquid is provided on the recording medium by utilizing any one system selected from the group consisting of a thermal ink jet system and a piezo ink jet system, and the second liquid is provided so as to be in contact with the region where the first liquid has been provided on the recording medium to thereby form an image.

16. An ink jet recording method according to claim 6, wherein the second liquid is provided on the recording medium in a liquid droplet state, and a weight of one droplet of the second liquid is 25 ng or less.

17. An ink jet recording device comprising: a recording head provided with two or more nozzles respectively jetting two or more liquids respectively onto a surface of a recording medium, the device using a first liquid and a second liquid as the two or more liquids, wherein:
at least one of the first and second liquids contains a colorant;
an image is formed at least by jetting the first liquid from the recording head onto the recording medium and jetting the second liquid from the recording head so as to be in contact with a region where the first liquid has been provided on the recording medium;
a contact angle of the second liquid with respect to plain paper is less than 85°; and
a contact angle of the second liquid with respect to the region where the first liquid is provided on the plain paper is 60° or more.

18. An ink jet recording device according to claim 17, wherein the first liquid contains at least a water-soluble solvent, a surfactant and water, and the second liquid contains at least a colorant, a water-soluble solvent and water.

19. An ink jet recording device according to claim 17, wherein the first liquid contains at least one additive selected from the group consisting of a silicone type compound and a fluorine type compound.

20. An ink jet recording device according to claim 17, wherein a number of coarse particles having a particle diameter of 0.5 μm or more which are contained in a mixed solution prepared by mixing the first and second liquids is 100,000 μL or less.
